(19) United States
(12) Patent Application Publication
(10) Pub. No.: US 2026/0321736 A1
(43) Pub. Date: Oct. 15, 2026

(54) ELECTRODE ASSEMBLY AND SECONDARY BATTERY COMPRISING THE ELECTRODE ASSEMBLY

(71) Applicant: SAMSUNG SDI CO., LTD., Yongin-si (KR)

(72) Inventor: Mi Sun LEE, Yongin-si (KR)

(21) Appl. No.: 19/317,313

(22) Filed: Sep. 3, 2025

(30) Foreign Application Priority Data
Apr. 11, 2025 (KR) 10-2025-0047265

(51) Int. Cl. H01M 10/0587; H01M 50/533

(52) U.S. Cl. CPC H01M 10/0587; H01M 50/533

(57) ABSTRACT

An electrode assembly including a first electrode; a second electrode; and a separator between the first electrode and the second electrode, the first electrode, the second electrode, and the separator are stacked and wound in a circular direction, the first electrode comprises a first current collector comprising a first uncoated portion; a first active material layer located on the first current collector; and a first electrode tab formed by the first uncoated portion, the second electrode comprises a second current collector including a second uncoated portion; a second active material layer located on the second current collector; and a second electrode tab formed by the second uncoated portion, the first electrode tab and the second electrode tab extend in opposite directions, and at least one electrode tab of the first electrode tab and the second electrode tab is wound the circular direction.

### CROSS-REFERENCE TO THE RELATED APPLICATION

The present application claims priority to and the benefit of Korean Patent Application No. 10-2025-0047265, filed on Apr. 11, 2025, in the Korean Intellectual Property Office, the entire disclosure of which is incorporated herein by reference.

### BACKGROUND

### 1. Field

Embodiments relate to an electrode assembly and a secondary battery.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The information disclosed in this section is provided only for enhancement of understanding of the background of the disclosure and therefore it may contain information that does not form the prior art.

### SUMMARY

Embodiments provide an electrode assembly and a secondary battery having improved heat dissipation characteristics.

An electrode assembly can include a first electrode, a second electrode, and a separator between the first electrode and the second electrode, wherein the first electrode, the second electrode, and the separator are stacked in a first direction and wound in a circular direction, wherein the first electrode comprises a first current collector comprising a first uncoated portion, a first active material layer provided on the first current collector, and a first electrode tab formed by the first uncoated portion, wherein the second electrode comprises a second current collector including a second uncoated portion, a second active material layer provided on the second current collector, and a second electrode tab formed by the second uncoated portion, wherein the first electrode tab and the second electrode tab each extend in opposite directions, and at least one electrode tab of the first electrode tab and the second electrode tab is wound in the circular direction.

In some configurations, the first electrode tab and the second electrode tab are wound into a spiral shape.

In some configurations, the first electrode tab and the second electrode tab are wound in the circular direction.

In some configurations, a first length of the first electrode and a second length of the second electrode before winding the first electrode tab and the second electrode tab are longer than the diameter of the electrode assembly.

In some configurations, the first electrode tab comprises a plurality of first electrode tabs, the plurality of first electrode tabs spaced apart in a direction of the diameter of the electrode assembly, the direction of the diameter comprising one of a major axis of the electrode assembly or a minor axis of the electrode assembly, the plurality of first electrode tabs are formed integrally, and the second electrode tab comprises a plurality of second electrode tabs, the plurality of second electrode tabs spaced apart in a direction of the diameter of the electrode assembly, the plurality of second electrode tabs formed integrally.

In some configurations, a first uncoated length of the first uncoated portion before winding of the first uncoated portion corresponds to a first current collector length of the first current collector before winding of the first current collector, and a second uncoated length of the second uncoated portion before winding of the second uncoated portion corresponds to a second current collector length of the second current collector before winding of the second current collector.

In some configurations, a first uncoated length of the first uncoated portion before winding of the first uncoated portion is smaller than a first current collector length of the first current collector before winding of the first current collector, and a second uncoated length of the second uncoated portion before winding of the second uncoated portion is shorter than a second current collector length of the second current collector before winding of the second current collector.

In some configurations, a first electrode tab width of the first electrode tab is longer than a first electrode tab length of the first electrode tab, and a second electrode tab width of the second electrode tab is longer than a second electrode tab length of the second electrode tab.

In some configurations, the first electrode tab is formed by bending the first uncoated portion, and the second electrode tab is formed by bending the second uncoated portion.

In some configurations, a pressure is applied to the first electrode tab and the second electrode tab, and the first uncoated portion and the second uncoated portion spaced apart in a direction of the diameter of the electrode assembly are in contact with each other by the pressure, the direction of the diameter comprising one of a major axis of the electrode assembly or a minor axis of the electrode assembly.

In some configurations, the first electrode tab comprises a first cutting region formed by cutting the first uncoated portion outside an outer diameter of the electrode assembly, and the second electrode tab comprise a second cutting region formed by cutting the second uncoated portion outside the outer diameter of the electrode assembly.

In some configurations, the first uncoated portion and the second uncoated portion are not notched.

In some configurations, a first notched region is formed at both ends of the first uncoated portion, and a second notched region is formed at both ends of the second uncoated portion.

In some configurations, the first electrode is a positive electrode, the second electrode is a negative electrode, and the second electrode tab is wound in one direction.

In some configurations, a second electrode tab area of the second electrode tab is longer than a first electrode tab area of the first electrode tab.

In some configurations, a second electrode tab width of the second electrode tab is longer than a first electrode tab width of the first electrode tab.

In some configurations, the first uncoated portion is notched to form a plurality of substrate tabs, and the first electrode tab is formed by welding the substrate tabs.

### BRIEF DESCRIPTION OF THE DRAWINGS

The accompanying drawings, which are incorporated in this specification, illustrate preferred embodiments and serve to further illustrate the technical ideas of the disclosure in conjunction with the detailed description of exemplary embodiments that follows, and the disclosure is not to be construed as limited to what is shown in such drawings. In the drawings:

FIG. 1 is a top view showing an example of a secondary battery according to an embodiment of the present disclosure.

FIG. 2 is a perspective view showing an example of an electrode assembly according to the embodiment after winding.

FIG. 3 is a top view showing an example of a first electrode of the electrode assembly according to the embodiment before winding.

FIG. 4 is a top view showing an example of a second electrode of the electrode assembly according to the embodiment before winding.

FIGS. 5 and 6 are drawings showing examples of winding and bending of the electrode assembly according to the embodiment.

FIG. 7 is a top view showing an example of the first electrode of the electrode assembly according to another embodiment before winding.

FIG. 8 is a top view showing an example of the second electrode of the electrode assembly according to another embodiment before winding.

FIG. 9 is a top view showing an example of the electrode assembly according to another embodiment after winding and bending.

FIG. 10 is a top view showing an example of the first electrode of the electrode assembly according to another embodiment before winding.

FIG. 11 is a top view showing an example of the electrode assembly after winding and bending according to another embodiment.

FIGS. 12 and 13 are drawings showing examples of temperature changes of the first electrode and the second electrode according to the size of the lead.

FIGS. 14 and 15 are perspective views showing an example of a battery pack including battery modules according to some embodiments.

FIGS. 16 and 17 are perspective views and a side view showing an example of a vehicle including battery packs according to some embodiments.

### DETAILED DESCRIPTION OF EXEMPLARY EMBODIMENTS

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components“.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

Hereinafter, an electrode assembly and a secondary battery according to an embodiment of the present disclosure will be described with reference to the drawings. The secondary battery may be classified into a cylindrical shape, a prismatic shape, a pouch shape, or a coin shape depending on the shape. The secondary battery described below may be applied to a pouch-type secondary battery.

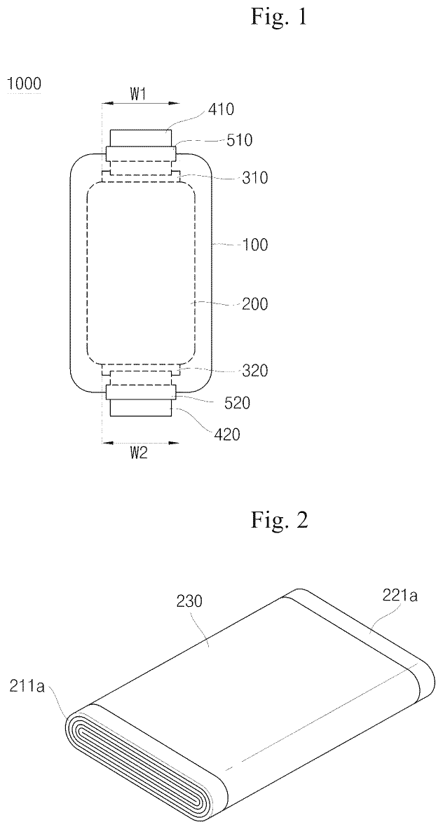

Referring to FIGS. 1 to 6, a secondary battery 1000 according to an embodiment of the present disclosure may include a case 100 and an electrode assembly 200.

The case 100 may include a housing part and a cap part. The electrode assembly may be housed in the housing part, and the electrode assembly may be covered by the cap part.

The edge of the case 100 may be sealed. Specifically, the edge of the case 100 may be sealed by a sealing part.

The electrode assembly 200 may be housed in the case 100. Specifically, the electrode assembly 200 may be housed in the housed space together with the electrolyte.

In the drawings, one electrode assembly 200 is housed in the case 100. However, the embodiment is not limited thereto. Two or more electrode assemblies may be housed in the case 100.

The electrode assembly 200 may include a first electrode 210, a second electrode 220, and a separator 230. The electrode assembly 200 may be formed by winding the first electrode 210, the second electrode 220, and the separator 230 in one direction (i.e., a circular direction). For example, the electrode assembly 200 may be formed by winding the first electrode 210, the second electrode 220, and the separator 230 in a jelly roll shape.

The first electrode 210 may include a first current collector 211 and a first active material layer 212. The first current collector 211 may include a metal foil such as aluminum or an aluminum alloy. The first active material layer 212 may include a transition metal oxide. For example, the first electrode 210 may be a positive electrode.

The first current collector 211 may include a first uncoated portion 211a. The first uncoated portion 211a is a portion of the first current collector 211 where the first active material layer (212) is not disposed.

The first electrode 210 may be connected to a first electrode tab 310. The first electrode tab 310 may be formed by the first uncoated portion 211a. Accordingly, the first electrode tab 310 may be formed from the same material as the first current collector 211. That is, the first electrode tab 310 may be formed integrally with the first current collector 211.

The second electrode 220 may include a second current collector 221 and a second active material layer 222. The second current collector 221 may include a metal foil such as copper, a copper alloy, nickel, or a nickel alloy. The second active material layer 222 may include graphite or carbon. For example, the second electrode 220 may be a negative electrode.

The second current collector 221 may include a second uncoated portion 221a. The second uncoated portion 221a is a portion of the second current collector 221 where the second active material layer 222 is not disposed.

The second electrode 220 may be connected to a second electrode tab 320. The second electrode tab 320 may be formed by the second uncoated portion 221a. Accordingly, the second electrode tab 320 may be formed from the same material as the second current collector 221. That is, the second electrode tab 320 may be formed integrally with the second current collector 221.

The first electrode tab 310 and the second electrode tab 320 may extend in different directions. For example, the first electrode tab 310 and the second electrode tab 320 may extend in opposite directions. For example, the first electrode tab 310 may be located on the electrode assembly 200, and the second electrode tab 320 may be located under the electrode assembly 200.

The separator 230 may prevent a short circuit between the first electrode 210 and the second electrode 220 while allowing the movement of lithium ions. The separator 230 may include a polyethylene film, a polypropylene film, or a polyethylene-polypropylene film.

The first electrode tab 310 and the second electrode tab 320 may each be connected to a lead. For example, the first electrode tab 310 may be connected to a first lead 410. The first electrode tab 310 may be connected to the first external terminal by the first lead 410. The second electrode tab 320 may be connected to a second lead 420. The second electrode tab 320 may be connected to the second external terminal by the second lead 420. The first lead 410 may be formed from the same material as the first electrode tab and the second lead 420 may be formed from the same material as the second electrode tab.

An insulating layer 500 may be located on the lead or on a portion of the lead. The insulating layer may be placed to surround the lead. For example, a first insulating layer 510 may be located on the first lead 410. A second insulating layer 520 may be located on the second lead 420. The lead 400 may be insulated from the case 100 by the insulating layer 500.

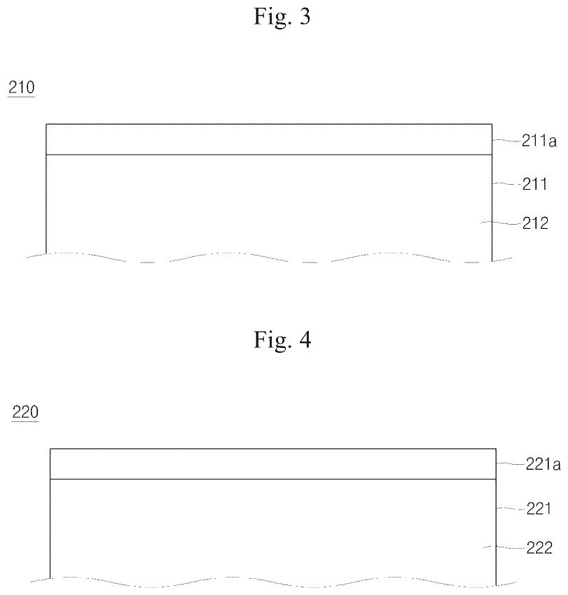

Referring to FIGS. 3 and 4, the first uncoated portion 211a may extend in one direction. For example, the first uncoated portion 211a may extend in the length direction of the first current collector 211. The length of the first uncoated portion 211a may correspond to the length of the first current collector 211.

The second uncoated portion 221a may extend in one direction. For example, the second uncoated portion 221a may extend in the length direction of the second current collector 221. The length of the second uncoated portion 221a may correspond to the length of the second current collector 221.

The first uncoated portion 211a and the second uncoated portion 221a may be wound in one direction without separate notching. Therefore, the first uncoated portion 211a and the second uncoated portion 221a may be extended in the winding direction of the first electrode and the second electrode. In addition, the first uncoated portion 211a and the second uncoated portion 221a may be formed in a spiral shape that is wound in one direction. Moreover, the length of the first uncoated portion 211a and the second uncoated portion 221a may be formed longer than the diameter of the electrode assembly.

The first uncoated portions 211a spaced apart in the direction of the diameter of the electrode assembly 200 may be connected to each other. That is, the first uncoated portions 211a spaced apart in the direction of the diametric of the electrode assembly 200 may be formed integrally. Furthermore, the second uncoated portions 221a spaced apart in the direction of the diameter of the electrode assembly 200 may be connected to each other. That is, the second uncoated portions 221a spaced apart in the direction of the diameter of the electrode assembly 200 may be formed integrally.

The first electrode tab 310 and the second electrode tab 320 formed by the first uncoated portion 211a and the second uncoated portion 221a may be formed in the shape and size of the first uncoated portion 211a and the second uncoated portion 221a.

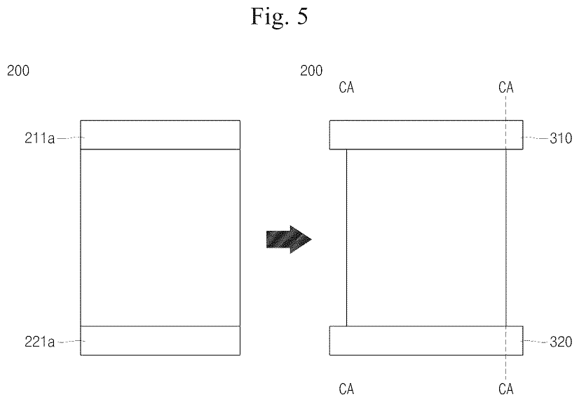

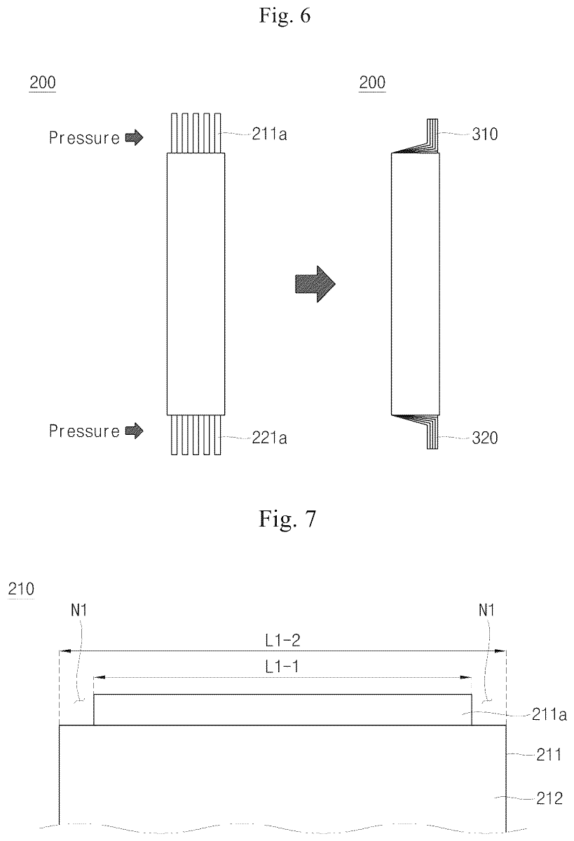

Referring to FIGS. 5 and 6, after the first electrode and the second electrode are wound, the first uncoated portion 211a and the second uncoated portion 221a may be bent. For example, after the first electrode and the second electrode are wound, pressure may be applied to the first uncoated portion 211a and the second uncoated portion 221a, thereby bending the first uncoated portion 211a and the second uncoated portion 221a.

Accordingly, the first uncoated portions 211a spaced apart in the direction of the diameter of the electrode assembly 200 may contact each other by pressure and the second uncoated portions 221a spaced apart in the direction of the diameter of the electrode assembly 200 may contact each other by pressure.

After pressure is applied to the first uncoated portion 211a and the second uncoated portion 221a, a portion of the first uncoated portion 211a or the second uncoated portion 221a may be outside the outer diameter of the electrode assembly 200. Accordingly, the portion of the first uncoated portion 211a or the second uncoated portion 221a that is outside the outer diameter of the electrode assembly 200 may be removed by cutting at the cutting region CA. Therefore, at least one of the first electrode tab 310 and the second electrode tab 320 may include the cutting region. The cutting region may be formed by removing a portion of the first uncoated portion 211a and the second uncoated portion 221a. Accordingly, the first electrode tab 310 is formed by the first uncoated portion 211a, and the second electrode tab 320 is formed by the second uncoated portion 221a.

The first electrode tab may be formed by the first uncoated portion and the second electrode tab may be formed by the second uncoated portion.

The first uncoated portion and the second uncoated portion are not notched separately. Thus, the length of the first uncoated portion 211a may correspond to the length of the first current corrector and the length of the second uncoated portion may correspond to the length of the second current collector. The first uncoated portion and the second uncoated portion are wound in one direction. Pressure can be applied to the first uncoated portion and the second uncoated portion.

Accordingly, the sizes of the first electrode tab formed by the first uncoated portion and the second electrode tab formed by the second uncoated portion may increase. For example, the width W1 of the first electrode tab may be formed longer than the length of the first electrode tab. That is, the size (width) of the first electrode tab in the X direction may be formed longer than the size (length) of the Y direction, and the width W2 of the second electrode tab may be formed longer than the size of the second electrode tab. That is, the size (width) of the second electrode tab in the X direction may be formed longer than the size (length) of the Y direction. For example, the width W1 of the first electrode tab and the width W2 of the second electrode tab may be the same as or similar to the diameter of the electrode assembly.

Accordingly, the size of the first lead connected to the first electrode tab may also be increased and the size of the second lead connected to the second electrode tab may also be increased. Accordingly, the movement area of the current flowing through the first lead and the second lead may increase. Accordingly, the resistance and heat generation of the first lead and the second lead may be reduced.

Since the sizes of the first electrode tab and the second electrode tab increase, the area of the heat dissipation layer formed on the electrode tabs may also increase. Accordingly, the temperature in the secondary battery may be prevented from increasing. That is, the temperature in the case may be prevented from increasing.

Accordingly, the secondary battery according to the embodiment may reduce the heat generation of the lead and the substrate tab connected to the lead. Accordingly, the secondary battery according to the embodiment may reduce heat generation of the lead and a substrate tab connected to the lead. Accordingly, the sealing layer of the case may be prevented from being opened by the heat generation. Also, it is possible to prevent an increase in the temperature in the case. Accordingly, the secondary battery may have improved performance and safety.

Hereinafter, the electrode assembly and the secondary battery according to another embodiment will be described with reference to FIGS. 7 to 9. Commonalities with the embodiment described above will be omitted. In addition, the same drawing reference numerals are given to the same configurations as those of the embodiment.

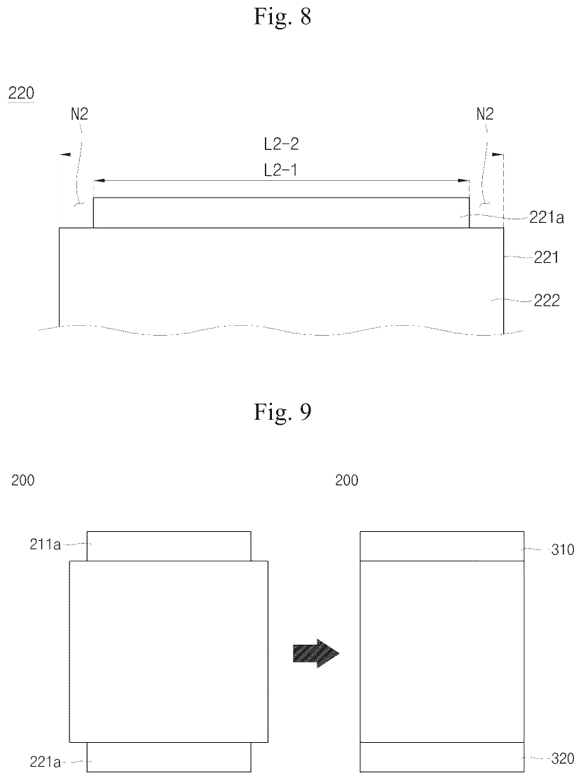

Referring to FIGS. 7 and 8, the first uncoated portion 211a may extend in one direction. For example, the first uncoated portion 211a may extend in the length direction of the first current collector 211 and the second uncoated portion 221a may extend in one direction. For example, the second unlined portion 221a may extend in the length direction of the second current collector 221.

The length of the first uncoated portion 211a may be different from the length of the first current collector 211. Specifically, the length L1-1 before winding of the first uncoated portion 211a may be different from the length L1-2 before winding of the first current collector 211. For example, the length L1-1 before winding of the first uncoated portion 211a may be smaller than the length L1-2 before winding of the first current collector 211.

For example, first notched regions N1 may be formed at both ends of the first uncoated portion 211a. Accordingly, some regions of both ends of the first uncoated portion 211a may be removed. Accordingly, the length of the first uncoated portion may be shorter than the length of the first current corrector.

The length of the second uncoated portion 221a may be different from the length of the second current collector 221. For example, the length L2-1 before winding of the second uncoated portion 221a may be different from the length L2-2 before winding of the second current collector 221. Likewise, the length L2-1 before winding of the second uncoated portion 221a may be smaller than the length L2-2 before winding of the second current collector 221.

For example, second notched regions N2 may be formed at both ends of the second uncoated portion 221a. Accordingly, some regions of both ends of the second uncoated portion 221a may be removed. Accordingly, the length of the second uncoated portion may be shorter than the length of the second current corrector.

Accordingly, the manufacturing process of the electrode assembly may be improved. Referring to FIG. 9, after the first electrode and the second electrode are wound, the first uncoated portion 211a and the second uncoated portion 221a may be bent. For example, after the first electrode and the second electrode are wound, pressure may be applied to the first uncoated portion 211a and the second uncoated portion 221a, thereby bending the first uncoated portion 211a and the second uncoated portion 221a.

Accordingly, the first uncoated portions 211a spaced apart in the direction of the diameter of the electrode assembly 200 may contact each other by pressure and the second uncoated portions 221a spaced apart in the direction of the diameter of the electrode assembly 200 may contact each other by pressure.

The width of the first uncoated portion 211a and the second uncoated portion 221a may be increased by the pressure. Accordingly, after bending, a portion of the first uncoated portion 211a or the second uncoated portion 221a may be outside the outer diameter of the electrode assembly 200.

However, the electrode assembly according to another embodiment includes the uncoated portion formed shorter than the length of the current corrector. In this example, after bending the uncoated portion, the uncoated portion area that is outside the outer diameter of the electrode assembly can be prevented from being formed. Moreover, a process of cutting the uncoated portion that is outside the outer diameter of the electrode assembly after bending the uncoated portion may be omitted. Therefore, the electrode assembly may be easily manufactured without a separate additional process.

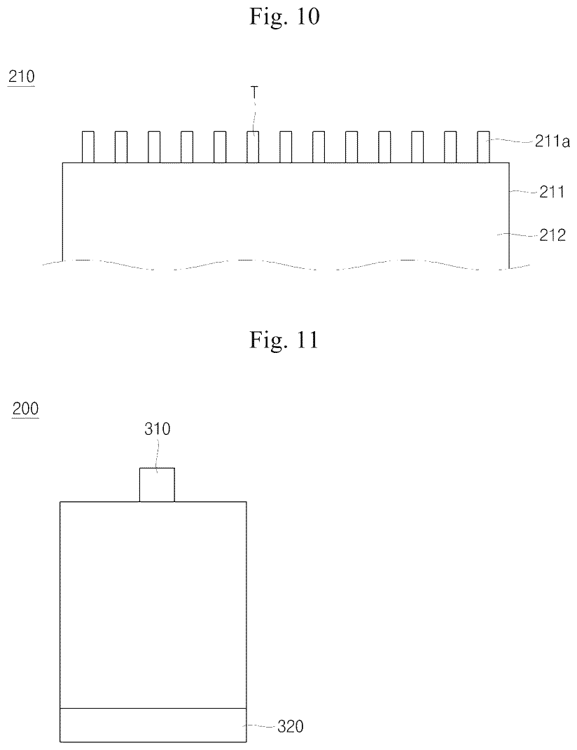

Hereinafter, the electrode assembly and the secondary battery according to another embodiment will be described with reference to FIGS. 10 to 12. Commonalities with the embodiment described above will be omitted. In addition, the same drawing reference numerals are given to the same configurations as those of the embodiment.

Referring to FIGS. 10 and 11, the first uncoated portion and the second uncoated portion may be formed in different shapes.

The second uncoated portion 221a may be formed in the same manner as in the previously described embodiment. For example, the second uncoated portion 221a may be formed as in FIG. 4 or FIG. 8.

The first uncoated portion 211a may form a plurality of substrate tabs T. For example, the first uncoated portion 211a may be notched, such that the first uncoated portion 211a may form a plurality of substrate tabs T by notching.

The second uncoated portion 221a may form the second electrode tab 320 in the same manner as in the previously described embodiment. The substrate tabs T formed by the first uncoated portion may be welded together after bending. Accordingly, the first electrode tab 310 may be formed. That is, the first electrode tab of the positive electrode is formed by welding a plurality of substrate tabs, and the second electrode tab of the negative electrode is formed by pressing the second uncoated portion after being wound in one direction.

The size of the first uncoated portion and the size of the second uncoated portion may be different. For example, the area of the second uncoated portion may be larger than the area of the first uncoated portion.

In addition, the size of the first electrode tab 310 and the size of the second electrode tab 320 may be different. For example, the size of the second electrode tab 320 may be larger than the size of the first electrode tab 310. As another example, the area of the second electrode tab 320 may be larger than the area of the first electrode tab 310. As yet another example, the width of the second electrode tab 320 may be larger than the width of the first electrode tab 310.

Accordingly, the sizes of the first lead 410 and the second lead 420 may also be different. For example, the size of the second lead 420 may be larger than the size of the first lead 410. As another example, the width of the second lead 420 may be larger than the width of the first lead 410. That is, since the width of the second electrode tab 320 is formed larger than the width of the first electrode tab 310, the welding region of the second lead 420 and the second electrode tab 320 may be larger than the welding region of the first lead 410 and the first electrode tab 310.

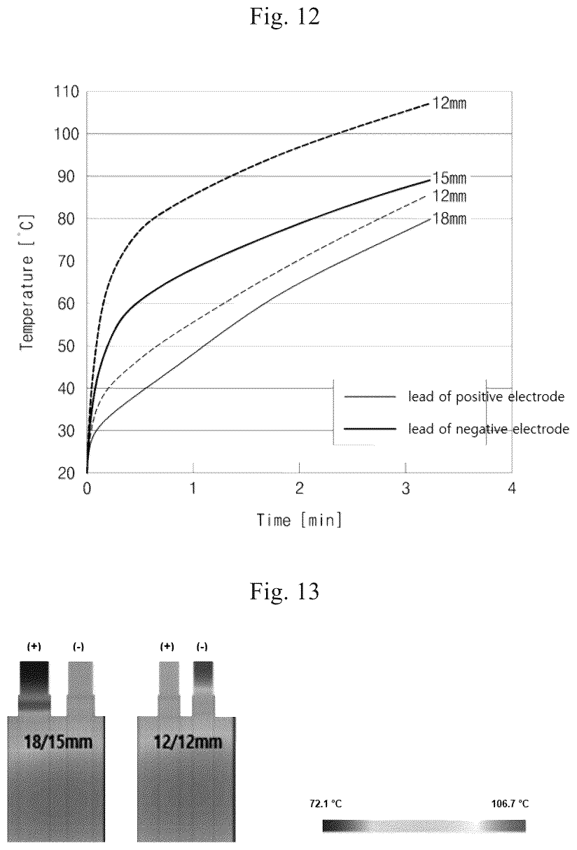

FIGS. 12 and 13 are drawings explaining the temperature change according to the width of the positive and negative leads. FIGS. 12 and 13 show the temperature change of the leads according to the change in the width of the positive and negative leads in a 15C charge/discharge experiment.

Referring to FIGS. 12 and 13, the temperature change of the leads may be seen when the width of the positive lead changes from 18 mm to 12 mm and the width of the negative lead changes from 15 mm to 12 mm.

When the width of the positive lead decreases by 6 mm, the temperature of the positive lead increases by about 6° C. On the other hand, when the width of the negative lead decreases by 3 mm, the temperature of the negative lead increases by about 18° C. That is, it can be seen that the negative lead has a greater temperature change according to the width than the positive lead.

In the electrode assembly according to another embodiment, sizes of the second uncoated portion and the first uncoated portion are different. Accordingly, the size of the second electrode tab is larger than the size of the first electrode tab. Accordingly, the size of the second lead is larger than the size of the first lead. That is, the size of the negative electrode lead is larger than a size of the positive electrode lead.

Accordingly, the internal temperature and resistance of the electrode assembly may be prevented from increasing due to the second electrode. The first electrode tab is formed by welding a plurality of substrate tabs. Accordingly, the first electrode tab may be located at various positions. Accordingly, the first lead may be withdrawn to a desired position. Accordingly, when electrically connecting a plurality of secondary batteries, the stacking shape of the secondary batteries may be varied.

The secondary battery according to the embodiment includes the first electrode tab and the second electrode tab extending in opposite directions.

The first electrode tab is formed by the first uncoated portion, and the second electrode tab is formed by the second uncoated portion.

The first uncoated portion and the second uncoated portion are formed to be the same as or similar to the length of the current collector. Therefore, in some configurations the sizes of the first electrode tab and the second electrode tab increase. Likewise, the sizes of the first lead and the second lead, which are respectively connected to the electrode tabs, increase.

In instances where the sizes of the first lead and the second lead increase, the heat generation and resistance of the first lead and the second lead may be reduced and the area of the heat dissipation layer formed on the first electrode tab and the second electrode tab may be increased.

The reduction in heat generation can prevent the temperature of the secondary battery from increasing. Therefore, the secondary battery according to the embodiment may have improved safety.

The secondary battery according to another embodiment includes the first electrode tab and the second electrode tab that extend in opposite directions.

The first electrode tab is formed by the first uncoated portion, and the second electrode tab is formed by the second uncoated portion.

The first uncoated portion and the second uncoated portion have different sizes. For example, the negative uncoated portion is formed larger than the positive uncoated portion. Accordingly, the electrode tab of the negative electrode is formed larger than the electrode tab of the positive electrode. Accordingly, the lead of the negative electrode is formed larger than the lead of the positive electrode. When charging and discharging the secondary battery, the heat generation of the negative electrode is larger than the heat generation of the positive electrode. Since the lead of the negative electrode is larger than the lead of the positive electrode, the heat generation size of the negative electrode may be reduced.

Accordingly, the temperature of the secondary battery is prevented from increasing. Accordingly, the secondary battery according to another embodiment may have improved safety.

The secondary battery may be used in portable small electronic devices such as smartphones, feature phones, notebook computers, digital cameras, and camcorders. In addition, a battery module and a battery pack including a plurality of secondary batteries may be used as a power source for driving a motor of a hybrid vehicle or an electric vehicle and as a battery for storing power.

The secondary battery described above may form a battery module. For example, the battery module may include a plurality of secondary batteries. The plurality of secondary batteries may be connected to each other in series, parallel, or series/parallel by a bus bar.

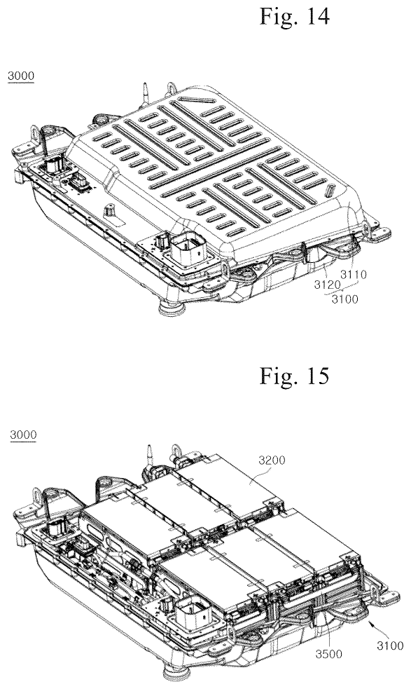

FIGS. 14 and 15 show a battery pack 3000 according to one or more example embodiments of the present disclosure. The battery pack 3000 may include a plurality of battery modules 3200 and a housing 3100 for accommodating the plurality of battery modules 3200. For example, the housing 3100 may include first and second housings 3110 and 3120 coupled in opposite directions through the plurality of battery modules 3200. The plurality of battery modules 3200 may be electrically connected to each other by using a bus bar 3500, and the plurality of battery modules 3200 may be electrically connected to each other in a series/parallel or series-parallel mixed method, thereby obtaining desired (e.g., required) electrical output. In the drawing, for convenience of illustration, parts such as bus bars, cooling units, and external terminals for electrical connection of secondary battery are omitted. In one or more example embodiments, battery pack 3300 may be mounted in a vehicle. The vehicle may be or include, for example, an electric vehicle, a hybrid vehicle, or a plug-in hybrid vehicle. A vehicle may include a four-wheeled vehicle or a two-wheeled vehicle.

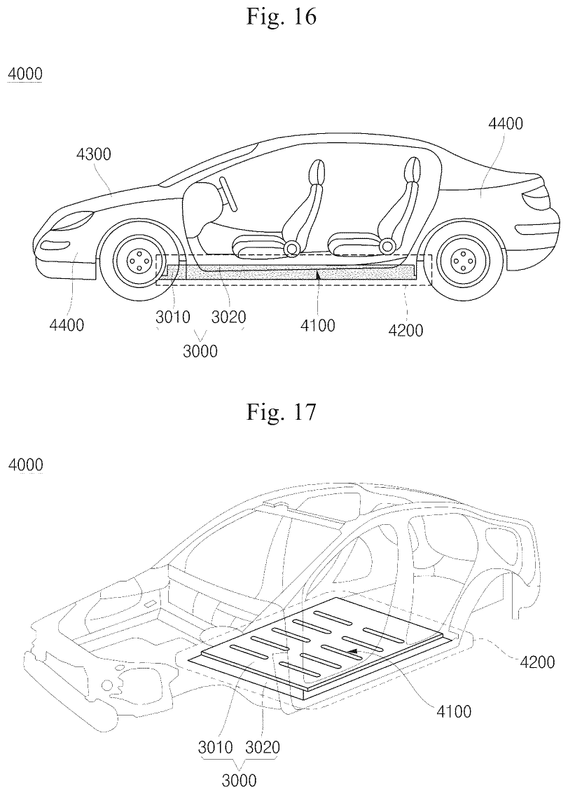

In FIG. 16, a battery pack 3000 may include a battery pack cover 3010, which is a part of a vehicle underbody 4100 and may correspond to the first housing, and a pack frame 3020, which is disposed under the vehicle underbody 4100 and may corresponding to the second housing. The battery pack cover 3010 and the pack frame 3020 may be, e.g., integrally formed with a vehicle floor 4200. The vehicle underbody 4100 separates the inside and outside of a vehicle, and the pack frame 3020 may be disposed outside the vehicle

In FIG. 17, a vehicle 4000 may be formed by combining additional parts, such as a hood 4300 in front of the vehicle 4000 and fenders 4400 respectively located in the front and rear of the vehicle 4000 to a vehicle body part. The vehicle 4000 may include the battery pack 3000 including the battery pack cover 3010 and the pack frame 3020, and the battery pack 3000 may be coupled to the vehicle body part.

The above is only one embodiment for implementing a secondary battery according to the disclosure, the disclosure is not limited to the above embodiment, and there is a technical spirit of the disclosure to the extent that various modifications can be made by anyone having ordinary skill in the art to which the disclosure pertains without departing from the gist of the disclosure.

What is claimed is:

1. An electrode assembly comprising:
a first electrode;
a second electrode; and
a separator between the first electrode and the second electrode,
wherein the first electrode, the second electrode, and the separator are stacked in a first direction and wound in a circular direction,
wherein the first electrode comprises:
a first current collector comprising a first uncoated portion;
a first active material layer provided on the first current collector; and
a first electrode tab formed by the first uncoated portion;
wherein the second electrode comprises:
a second current collector comprising a second uncoated portion;
a second active material layer provided on the second current collector; and
a second electrode tab formed by the second uncoated portion,
wherein the first electrode tab and the second electrode tab extend in opposite directions, and
wherein at least one electrode tab of the first electrode tab and the second electrode tab is wound in the circular direction.

2. The electrode assembly as claimed in claim 1, wherein the first electrode tab and the second electrode tab are wound into a spiral shape.

3. The electrode assembly as claimed in claim 1, wherein the first electrode tab and the second electrode tab are wound in the circular direction.

4. The electrode assembly as claimed in claim 3, wherein a first length of the first electrode and a second length of the second electrode before winding the first electrode tab and the second electrode tab are longer than a diameter of the electrode assembly.

5. The electrode assembly as claimed in claim 3, wherein the first electrode tab comprises a plurality of first electrode tabs, the plurality of first electrode tabs are spaced apart in a direction of a diameter of the electrode assembly, with the direction of the diameter comprising one of a major axis of the electrode assembly or a minor axis of the electrode assembly, the plurality of first electrode tabs being formed integrally, and
wherein the second electrode tab comprises a plurality of second electrode tabs, the plurality of second electrode tabs are spaced apart in the direction of the diameter of the electrode assembly, the plurality of second electrode tabs being formed integrally.

6. The electrode assembly as claimed in claim 3, wherein:
a first uncoated length of the first uncoated portion before winding of the first uncoated portion corresponds to a first current collector length of the first current collector before winding of the first current collector, and
wherein a second uncoated length of the second uncoated portion before winding of the second uncoated portion corresponds to a second current collector length of the second current collector before winding of the second current collector.

7. The electrode assembly as claimed in claim 3,
wherein a first uncoated length of the first uncoated portion before winding of the first uncoated portion is shorter than a first current collector length of the first current collector before winding of the first current collector, and
wherein a second uncoated length of the second uncoated portion before winding of the second uncoated portion is shorter than a second current collector length of the second current collector before winding of the second current collector.

8. The electrode assembly as claimed in claim 3,
wherein a first electrode tab width of the first electrode tab is longer than a first electrode tab length of the first electrode tab, and
wherein a second electrode tab width of the second electrode tab is longer than a second electrode tab length of the second electrode tab.

9. The electrode assembly as claimed in claim 1,
wherein the first electrode tab is formed by bending the first uncoated portion, and
wherein the second electrode tab is formed by bending the second uncoated portion.

10. The electrode assembly as claimed in claim 9, wherein
a pressure is applied to the first electrode tab and the second electrode tab, and
wherein the first uncoated portion and the second uncoated portion are spaced apart in a direction of a diameter of the electrode assembly are in contact with each other by the pressure, the direction of the diameter comprising one of a major axis of the electrode assembly or a minor axis of the electrode assembly.

11. The electrode assembly as claimed in claim 10,
wherein the first electrode tab comprises a first cut region formed by cutting the first uncoated portion outside an outer diameter of the electrode assembly, and
wherein the second electrode tab comprise a second cut region formed by cutting the second uncoated portion outside the outer diameter of the electrode assembly.

12. The electrode assembly as claimed in claim 1, wherein the first uncoated portion and the second uncoated portion are not notched.

13. The electrode assembly as claimed in claim 1,
wherein a first notched region is formed at ends of the first uncoated portion, and
wherein a second notched region is formed at ends of the second uncoated portion.

14. The electrode assembly as claimed in claim 1,
wherein the first electrode is a positive electrode,
wherein the second electrode is a negative electrode, and
wherein the second electrode tab is wound in one direction.

15. The electrode assembly as claimed in claim 14, wherein a second electrode tab area of the second electrode tab is larger than a first electrode tab area of the first electrode tab.

16. The electrode assembly as claimed in claim 14, wherein a second electrode tab width of the second electrode tab is longer than a first electrode tab width of the first electrode tab.

17. The electrode assembly as claimed in claim 14,
wherein the first uncoated portion is notched to form a plurality of substrate tabs, and
wherein the first electrode tab is formed by welding the substrate tabs.

18. A secondary battery comprising:
a case;
an electrode assembly of claim 1 housed in the case;
a first lead connected to the first electrode tab; and
a second lead connected to the second electrode tab.

19. The secondary battery as claimed in claim 18,
wherein a second electrode tab welding region of the second electrode tab and the second lead is larger than a first electrode tab welding region of the first electrode tab and the first lead.

20. The secondary battery as claimed in claim 18, wherein a second lead width of the second lead is longer than a first lead width of the first lead.
